(19) United States
(12) Patent Application Publication
(10) Pub. No.: US 2012/0140261 A1
(43) Pub. Date: Jun. 7, 2012

(54) METHOD AND SYSTEM FOR PROVIDING PRINT GOVERNANCE INTERACTION FOR REMOTE RENDERING APPLICATIONS

(75) Inventor: Matthew DeRoller, Webster, NY (US)

(73) Assignee: Xerox Corporation, Norwalk, CT (US)

(21) Appl. No.: 12/959,066

(22) Filed: Dec. 2, 2010

(51) Int. Cl. G06K 15/02

(52) U.S. Cl. 358/1.14

(57) ABSTRACT

A method, system and computer-usable medium for providing print governance interaction with respect to a remote rendering application via an EIP workflow. A rendering job in association with address information of a desired rendering device can be transmitted from a mobile communications device to a mobile print server via a rendering job submission tool. A print governance module configured in association with the mobile print server provides a confirmation code to the mobile device and the confirmation code can be entered via the EIP application configured at the rendering device in order to retrieve the rendering job. A print governance message can be displayed at a user interface of the rendering device if the rendering job activity bypasses a print governance policy. The EIP application further permits a user to make changes to the rendering job activity that bypasses the print governance policy via an option button in order to provide an effective print governance solution in a wide range of remote rendering applications.

### TECHNICAL FIELD

Embodiments are generally related to rendering devices such as, for example, printers, scanners, photocopy machines, multi-function devices and the like. Embodiments are also related to mobile rendering techniques. Embodiments are additionally related to the enforcement of print governance for remote rendering applications.

### BACKGROUND OF THE INVENTION

Networked rendering devices can interact with an assemblage of other rendering devices, client devices, servers, etc., and other components that can communicate with one another over an electronic communications network. One example of a rendering device is an MFD (Multi-Function Device), which includes the functionality of multiple rendering devices such as printers, scanners, faxes, copy machines, and so forth. Each MFD in a network, for example, can include a variety of print capability options such as, finishing, media quality, supply levels and size. Such networked rendering devices can be communicatively linked with one or more mobile communications devices in order to provide various operations such as, for example, printing, scanning, and other operations via the network.

The mobile communications device can utilize a rendering job submission tool such as, for example, an e-mail application that permits a user to render a job from the mobile device. For example, a rendering job can be submitted as an e-mail attachment and a desired rendering device can be selected by including an IP (internet protocol) address and/or a friendly name associated with the rendering device in the e-mail. The rendering job can also be submitted to a general mobile print queue and then released at the desired rendering device via a “Follow Me” print technology (e.g., extensible interface platform).

With the proliferation of color rendering devices, a managed rendering service provider deploys an output management solution for governing the use of rendering documents with respect to a customer. Such output management solutions must be managed correctly when deployed as part of a managed services agreement in order to ensure cost effective print governance. A print governance application typically monitors a print request and enforces a business rule in order to maximize the rendering efficiency by reducing consumables such as, for example, toner and paper and redirects the rendering job to a more cost effective rendering device. A majority of prior art output management solutions are unable to enforce the print governance policies when the rendering job is remotely submitted from the mobile communications device and released at the rendering device. Such prior art approaches, however, lack the ability to track and measure the mobile print activity and “Follow-You” print workflow that bypasses the print governance policy and/or rule with respect to the print governance application.

Based on the foregoing, it is believed that a need exist for an improved system and method for providing a print governance interaction with respect to a remote rendering application via an extensible interface platform (EIP) workflow, as described in greater detail herein.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved method and system for configuring a networked rendering device such as, for example, a printer, scanner, photocopy machine, fax machine, and/or an MFD.

It is another aspect of the disclosed embodiments to provide for an improved system and method for providing a print governance interaction with respect to a remote rendering application.

It is a further aspect of the disclosed embodiments to provide for an improved system and method for configuring an extensible interface platform (EIP) workflow with respect to the remote rendering application.

The aforementioned aspects and other objectives and advantages can now be achieved as described herein. A method, system and computer-usable medium for providing print governance interaction with respect to a remote rendering application via an EIP workflow are disclosed herein. A rendering job in association with address information (e.g., an IP address, a friendly name) of a desired rendering device can be transmitted from a mobile communications device to a mobile print server via a rendering job submission tool (e.g., an e-mail application). A print governance module configured in association with the mobile print server provides a confirmation code to the mobile device and the confirmation code can be entered via the EIP application configured at the rendering device in order to retrieve the rendering job. A print governance message can be displayed at a user interface of the rendering device if the rendering job activity bypasses a print governance policy. The EIP application further permits a user to make changes to the rendering job activity that bypasses the print governance policy via an option button in order to provide an effective print governance solution in a wide range of remote rendering applications.

The remote rendering job with respect to the rendering device can be transmitted via the mobile communications device such as, a PDA, a laptop, etc. The rendering job can be transmitted to the appropriate rendering device in the network and the confirmation code with respect to the rendering job can also be provided to the user. The print governance messages can be presented to the user as EIP application dialogues while releasing the rendering job. The print governance messages provides detailed information and actions to be taken when the rendering job bypasses the print governance policies. Such an approach leverages the existing mobile print workflow for providing the print governance interaction within the network without any additional software requirement in the mobile communication device. Such a system and method leverages existing mobile print technologies and extends managed print services with respect to a remote and mobile work force.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates an example of a rendering device coupled to a data-processing apparatus through a network, in accordance with the disclosed embodiments;

FIG. 2 illustrates a block diagram of a remote print governance management system associated with various client devices and network-accessible devices, in accordance with the disclosed embodiments;

FIG. 3 illustrates a block diagram of the remote print governance management system, in accordance with the disclosed embodiments;

FIG. 4 illustrates a high level flow chart of operation illustrating logical operational steps of a method for providing print governance interaction with respect to a remote rendering application via an EIP workflow, in accordance with the disclosed embodiments; and

FIGS. 5-6 illustrate GUI of a print governance message that provides detailed information and actions to be taken when a rendering job bypasses a print governance policy, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

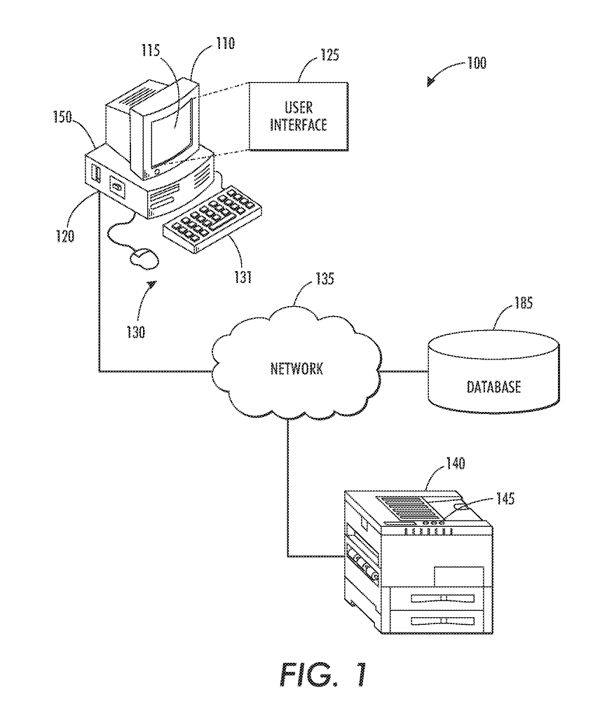

FIG. 1 is provided as an exemplary diagram of data-processing environments in which embodiments of the present invention may be implemented. It should be appreciated that FIG. 1 is only exemplary and is not intended to assert or imply any limitation with regard to the environments in which aspects or embodiments of the present invention may be implemented. Many modifications to the depicted environments may be made without departing from the spirit and scope of the present invention.

Referring to FIG. 1, system 100 includes a rendering device 140 coupled to a data-processing apparatus 110 through a network 135. In some embodiments, rendering device 140 may be, for example, a rendering device such as a printer, scanner, copy machine, etc. In other embodiments, rendering device 140 can be an MFD (Multi-Function Device). Additionally, the data-processing apparatus 110 may be, for example, a personal computer or other computing device (e.g., Smartphone, laptop computer, portable computing device, etc), and generally includes a central processor 120, a display device 115, a keyboard 131, and a pointing device 130 (e.g., mouse, track ball, pen device, or the like). Additional input/output devices, such as the rendering device 140 may be included in association with the data-processing apparatus 110 as desired.

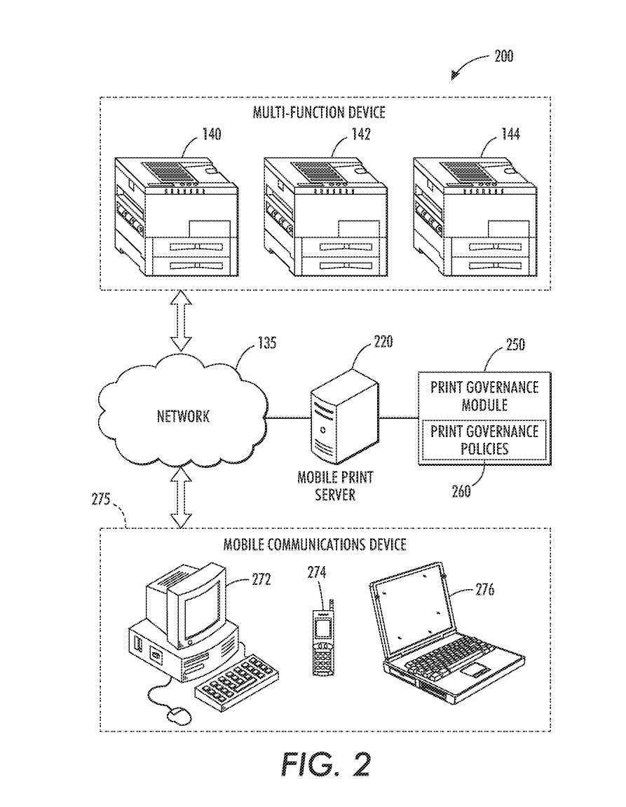

Note that as utilized herein, the term rendering device may refer to an apparatus or system such as a printer, scanner, fax machine, copy machine, etc., and/or a combination thereof (e.g., an MFD). Preferably, rendering device 140 is an MFD capable of multiple rendering functions such as printing, copying, scanning, faxing, etc. In some embodiments, the rendering device 140 may be implemented with a single rendering function such as printing. In other embodiments, the rendering device 140 can be configured to provide multiple rendering functions, such as scanning, faxing, printing and copying. Note that the rendering devices 142 and 144 illustrated herein with respect to FIG. 2 are generally analogous or similar to rendering device 140.

A non-limiting example of an MFD that can be utilized as one or more of rendering devices 140, 142 and/or 144 is disclosed in U.S. Pat. No. 7,525,676, entitled “System and Method for Controlling Access to Programming Options of a Multifunction Device,” which issued on Apr. 28, 2009 to Robert J. Pesar. U.S. Pat. No. 7,525,676, which is incorporated herein by reference in its entirety, is assigned to the Xerox Corporation of Norwalk, Conn. Another non-limiting example of an MFD that can be utilized as rendering devices 140, 142 and/or 144 is disclosed in U.S. Pat. No. 7,474,428, entitled “Multifunction Device System Using Tags Containing Output Information,” which issued on Jan. 6, 2009 to Morris-Jones, et al. U.S. Pat. No. 7,474,428, which is incorporated herein by reference in its entirety, is also assigned to the Xerox Corporation of Norwalk, Conn. An additional example of an MFD that can be utilized as rendering devices 140, 142 and/or 144 is disclosed in U.S. Pat. No. 5,920,405, entitled “Multifunction Device With Printer Facsimile Contention Selection,” which issued on Jul. 6, 1999 to McIntyre, et al. U.S. Pat. No. 5,920,405, which is incorporated herein by reference in its entirety, is also assigned to the Xerox Corporation of Norwalk, Conn.

The data-processing apparatus 110 can be coupled to the rendering device 140 (and other rendering devices) through a computer network 135. Network 135 may employ any network topology, transmission medium, or network protocol. The network 135 may include connections, such as wire, wireless communication links, or fiber optic cables. In the depicted example, network 135 is the Internet representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages.

The rendering device 140 includes a user interface 145, such as a panel menu. The panel menu may be used to select features and enter other data in the rendering device 140. Such interfaces may include, for example, touch screens having touch activated keys for navigating through an option menu or the like. A driver program, for example, can be installed on the data-processing apparatus 110 and can reside on the host device's hard drive 150. The driver program may be activated through an application interface so that a user may generate a print job with the driver for processing by the rendering device 140.

The data-processing apparatus 110 also includes a GUI 125 for communicating rendering features for processing, for example, a print job to a user and accepting the user's selection of available rendering features. The user interface 125 displays information and receives data through device display and/or the keyboard/mouse combination. The interface 125, also serves to display results, whereupon the user may supply additional inputs or terminate a given session. The data-processing apparatus 110 can be, for example, any computing device capable of being integrated within a network, such as a PDA, personal computer, cellular telephone, point-of-sale terminal, server, etc.

Note that the user interface as utilized herein generally refers to a type of environment that represents programs, files, options and so forth by means of graphically displayed icons, menus, and dialog boxes on a screen. The input device of the rendering device 140, for example, may be a local user interface 125, such as a touch-screen display or separate keypad and display or a memory fob or the like as discussed above. Alternatively or additionally, the input device may be a wireless port that receives a wireless signal containing constraint data from a portable device. The wireless signal may be an infrared or electromagnetic signal. A system administrator may input constraint data through the local user interface by manipulating the touch screen, keypad, or communicating via wireless messages through the wireless port. The administrator's portable device that communicates wirelessly may be a personal digital assistant (PDA), or the like, as noted above.

The following description is presented with respect to embodiments of the present invention, which can be embodied in the context of a data-processing apparatus 110 and rendering device 140 depicted in FIG. 1. The present invention, however, is not limited to any particular application or any particular environment. Instead, those skilled in the art will find that the system and methods of the present invention may be advantageously applied to a variety of system and application software, including database management systems, word processors, and the like. Moreover, the present invention may be embodied on a variety of different platforms, including Macintosh, UNIX, LINUX, and the like. Therefore, the description of the exemplary embodiments, which follows, is for purposes of illustration and not considered a limitation.

FIG. 2 illustrates a block diagram of a remote print governance management system 200 associated with various client devices and network-accessible devices, in accordance with the disclosed embodiments. The system 200 generally includes one or more rendering devices, such as, for example, devices 140, 142 and/or 144, which can provide one or more designated operations such as printing, scanning and/or device discovery operations. Rendering devices 140, 142 and/or 144 may each be, in some embodiments a distinct MFD. The system 200 also includes one or more client devices 275 (e.g., mobile communications devices) such as, for example, a personal computer 272, a laptop computer 276 or another computing apparatus or system 274 (e.g., wireless cellular telephone, Smartphone, etc) that are operatively configured in association with the network 135. The client device 275 can communicate with the rendering device 140 via the network 135.

A mobile print server 220 is configured in association with a print governance module 250 for providing print governance interaction with respect to a remote rendering application 308 via an EIP workflow. The mobile print server 220 can be typically employed to transmit the remote rendering job 308 along with address information of the rendering device 140 from the mobile communications device 275 to the mobile print sever 220. The mobile print server 220 provides data, such as boot files, operating system images, and applications to the client device 275. Specifically, clients may connect to any member of a network of mobile print server 220 which provides equivalent content. In the depicted example, the mobile print server 220 connects to and communicates with the network 135 along with the print governance module 250.

Note that as utilized herein, the term “module” may refer to a physical hardware component and/or to a software module. In the computer programming arts, such a software “module” may be implemented as a collection of routines and data structures that performs particular tasks or implements a particular abstract data type. Modules of this type are generally composed of two parts. First, a software module may list the constants, data types, variable, routines, and so forth that can be accessed by other modules or routines. Second, a software module may be configured as an implementation, which can be private (i.e., accessible only to the module), and which contains the source code that actually implements the routines or subroutines upon which the module is based.

Therefore, when referring to a “module” herein, the inventors are generally referring to such software modules or implementations thereof. The methodology described herein can be implemented as a series of such modules or as a single software module. Such modules can be utilized separately or together to form a program product that can be implemented through signal-bearing media, including transmission media and recordable media. The present invention is capable of being distributed as a program product in a variety of forms, which apply equally regardless of the particular type of signal-bearing media utilized to carry out the distribution.

Examples of signal-bearing media can include, for example, recordable-type media, such as floppy disks, hard disk drives, CD ROMs, CD-Rs, etc., and transmission media, such as digital and/or analog communication links. Examples of transmission media can also include devices such as modems, which permit information to be transmitted over standard telephone lines and/or the more advanced digital communications lines.

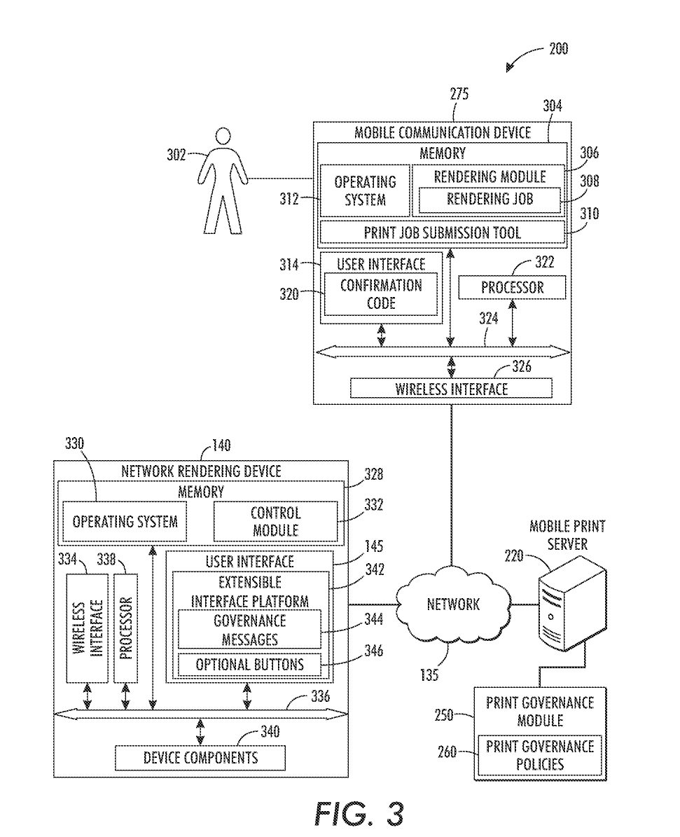

FIG. 3 illustrates a block diagram of the remote print governance management system 200, in accordance with the disclosed embodiments. Note that in FIGS. 1-6, identical or similar blocks are generally indicated by identical reference numerals. The remote print governance management system 200 provides an effective print governance interaction for a wide range of remote rendering job application 308. The print governance system 200 associated with the mobile print server 220 permits a user 302 to access the rendering device 140 in a non-office environment, such as an airport lounge, hotel, university campuses, conference centers, libraries, and hotels.

The print governance management system 200 includes the mobile communications device 275, the multifunction device 140, and the mobile print server 220 that are communicated through the network 135. The mobile communications device 275 can be such as, for example, a Smartphone, a personal digital assistant (PDA), and the like which offers a wide range of capabilities including storing and editing documents, receiving and sending electronic mails and storing/viewing images. The mobile communications device 275 includes a user interface 314, a memory 304 and a processor 322 coupled to a local interface 324.

The local interface 324 can be for example, a data bus with an accompanying control/address bus. A wireless interface 326 facilitates wireless communication with the rendering device 140, the mobile print server 220 and other wireless devices and/or networks. The memory 304 stores several components that are executable by the processor 322. The components include, for example, an operating system 312, a rendering job submission tool 310, the rendering job 308, and a rendering module 306.

The rendering device 140 includes a processor circuit having a memory 328 and a processor 338 coupled to a local interface 336. The memory 328 stores an operating system 330 and a control module 332 that are executable by the processor 338. The rendering device 140 also includes a user interface 145 and various rendering device components 340 such as motors and mechanical paper path components as well as image creation components. A wireless network interface 334 coupled to the local interface 336 facilitates wireless communication with respect to the rendering device 140. An extensible interface platform (EIP) application 342 can be configured in association with the rendering device 140 for providing print governance interaction with respect to the remote rendering job 308. The EIP application 342 can be a software platform upon which a developer employs standard web-based tools to create server-based applications that can be configured for the rendering device user interface 145.

The rendering job 308 in association with address information (e.g., an IP address, a friendly name) of a desired rendering device 140 can be transmitted from the mobile communications device 275 to the mobile print server 220 via the rendering job submission tool 310 (e.g., an e-mail application). The print governance module 250 configured in association with the mobile print server 220 provides a confirmation code 320 to the mobile device and the confirmation code 320 can be entered via the EIP application 342 configured at the rendering device 140 in order to retrieve the rendering job 308. A print governance message 344 can be displayed at the user interface 145 of the rendering device 140 if the rendering job 308 activity bypasses the print governance policy 260. The EIP application 342 further permits the user 302 to make changes to the rendering job activity 308 that bypasses the print governance policy 260 via an option button 346 in order to provide an effective print governance solution in a wide range of remote rendering applications.

The EIP application 342 associated with the rendering device 140 permits the user 302 to enter the confirmation code 320 and make appropriate changes to the rendering job 308 before retrieving. The print governance system 200 provides print governance interaction to the remote user 302 utilizing one or more print technologies, such as, Follow-Me print technology and Follow-You print technology. The Follow-Me print technology is based upon the mobile communications device 275 which spools the rendering job 308 to the mobile print server 220 in order to enforce the print governance policies 260 until the rendering job 308 is released by the user 302. The Follow-You Print technology permits the user 302 to submit the rendering jobs 308 to a general queue, and then release the rendering jobs 308 at the rendering device 140 of choice. The rendering job 308 releasing mechanism can be authenticated with the confirmation code 320. Note that a card reader can also be employed for authentication process.

The remote rendering job 308 with respect to the rendering device 140 can be transmitted via the mobile communications device 275 such as, a PDA, a laptop, etc. The rendering job 308 can be transmitted to the appropriate rendering device 140 in the network 135 and the confirmation code 320 with respect to the rendering job 308 can also be provided to the user 302. The print governance messages 344 can be presented to the user 302 as EIP application dialogues at the time of releasing the rendering job 308. The print governance message 344 provides detailed information and actions to be taken when the rendering job 308 bypasses the print governance policies 260. Note that the user interface 314 and/or 145 may be implemented utilizing a GUI such as, for example, the GUI 153 depicted in FIG. 1 herein, and may be provided by a module, such as, for example, a software application module. User interface 314 and/or 145 can be displayed via a display device such as, for example, the monitor 115 depicted in FIG. 1. Such system 200 provides an effective print governance solution in a wide range of remote rendering applications.

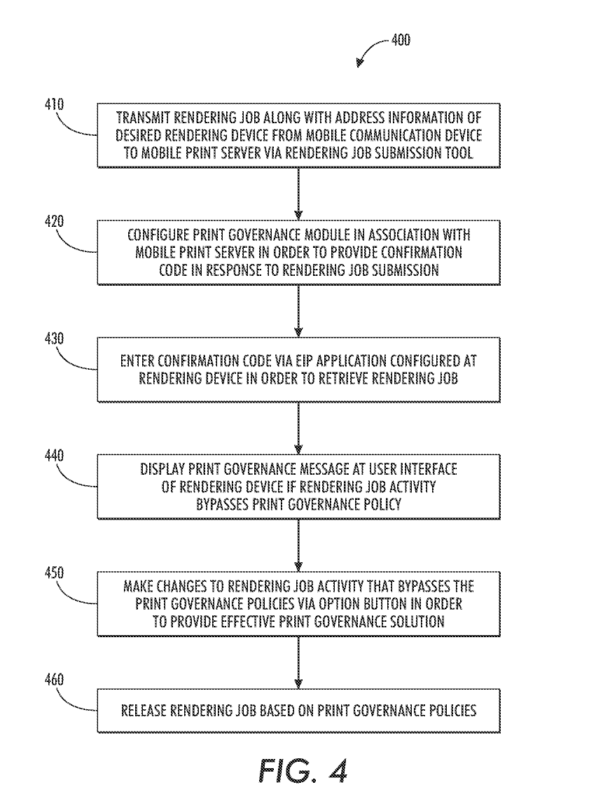

FIG. 4 illustrates a high level flow chart of operation illustrating logical operational steps of a method 400 for providing a print governance interaction to the remote rendering job application 308 in the context of the environment of network 135, in accordance with the disclosed embodiments. Note that the method 400 can be implemented in the context of a computer-useable medium that contains a program product, including, for example, a module or group of modules. The rendering job 308 along with address information of the desired rendering device 140 can be transmitted from the mobile communications device 275 to the mobile print server 220 via the rendering job submission tool 310, as illustrated at block 410. The print governance module 250 can be configured in association with the mobile print server 220 in order to provide the confirmation code 320 in response to the print job submission, as depicted at block 420. The confirmation code 320 transmitted to the user 302 can be entered at the rendering device 140 via the EIP application 342 configured at the rendering device 140 in order to retrieve the rendering job 308, as indicated at block 430.

The print governance message 344 with respect to the rendering job 308 can be displayed at the user interface 145 of the rendering device 140 via the EIP application 342, as illustrated at block 440. Thereafter, the user 302 can be permitted to make appropriate changes to the rendering job 308 activity that bypasses the print governance policies 260 via the optional button 346 associated with the user interface of the rendering device 140 in order to provide effective print governance solution, as depicted at block 450. Finally, the rendering job 308 can be released at the desired rendering device 140 based on the print governance policies 260, as indicated at block 460. Such an approach leverages the existing mobile print workflow for providing the print governance interaction to the rendering job 308 within the network 135 without any additional software requirement in the mobile communications device 275.

Note that programs defining functions with respect to the disclosed embodiments may be delivered to a data storage system or a computer system via a variety of signal-bearing media, which include, without limitation, non-writable storage media (e.g., CD-ROM), writable storage media (e.g., hard disk drive, read/write CD ROM, optical media), system memory such as but not limited to Random Access Memory (RAM), and communication media, such as computer and telephone networks including, for example, Ethernet, the Internet, wireless networks, other networked systems. Thus, the method 400 described herein can be deployed as process software in the context of a computer system or data-processing system as that depicted in FIGS. 1-2.

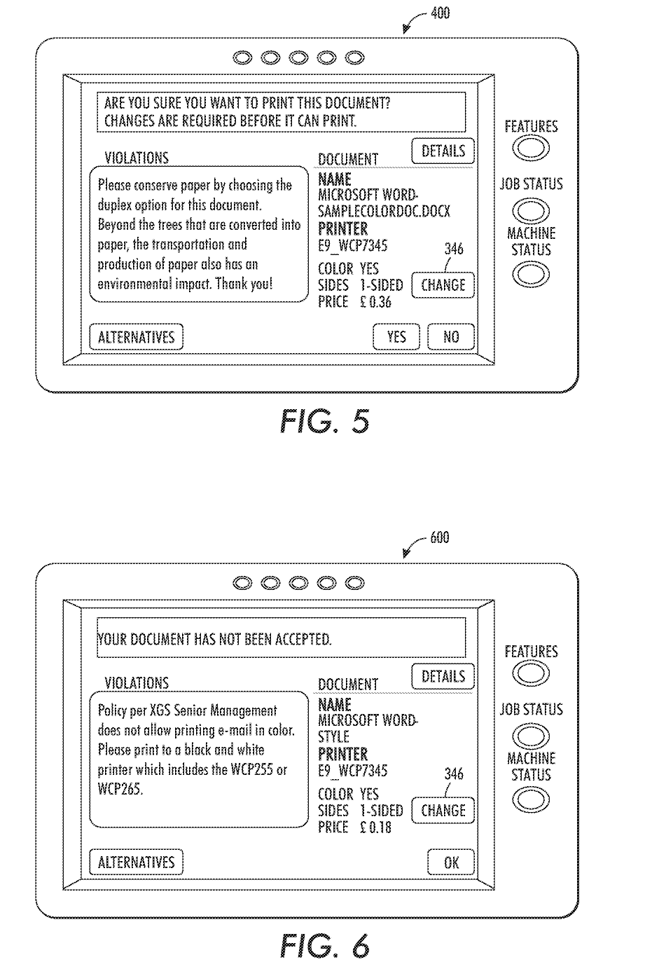

FIG. 5 and FIG. 6 illustrate GUI 500 and 600 of a print governance message generated at the user interface 145 of the rendering device 140 with respect to the rendering job 308, in accordance with the disclosed embodiments. Again as a reminder, note that in FIGS. 1-6, identical or similar parts are generally indicated by identical reference numerals. Note that the GUI 500 and/or 600 can be implemented utilizing a GUI such as, for example, the GUI 145 depicted in FIG. 1 herein, and may be provided by a module, such as, for example, module 250 (i.e., a software application). GUI 500 and/or 600 can be displayed via a display device such as monitor 115 depicted in FIG. 1. In the illustrated figures herein, 500, and/or 600 are generally implemented in the context of a GUI “window”. Note that in computing, a GUI window is generally a visual area containing some type of user interface (e.g., GUI 145). Such a “window” usually (but not always) possesses a rectangular shape, and displays the output of and may allow input to one or more processes. Such windows are primarily associated with graphical displays, where they can be manipulated with a mouse cursor, such as, for example, the pointing device 130 depicted in FIG. 1. A GUI using windows as one of its main “metaphors” is often referred to as a windowing system.

The GUI 500 illustrates a print governance message as the rendering job activity bypasses the print governance policy 260. The GUI 500 associated with the rendering device 140 may include, for example, a graphically displayed dialogue box 510 that provides an action message to change the paper rendering option from one-sided to duplex in order to conserve paper. The changes can be made to the rendering job 308 by clicking the graphically displayed optional button 346 provided by the EIP application 342 associated with the rendering device 140.

Note that the term interface as utilized herein generally refers to a type of environment that represents programs, files, options and so forth by means of graphically displayed icons, menus, and dialog boxes on a screen. The user can interact with the GUI to select and activate such options by pointing and clicking with a user input device such as, for example, a touch screen, a key board, a mouse, and so forth. A particular item may function in the same manner to the user in all applications because the user interface provides standard software routines to handle these elements and reports the user's actions.

The GUI 600 illustrates another print governance message as the rendering job activity bypasses the print governance policy 260. The GUI 600 associated with the rendering device 140 may include, for example, a graphically displayed dialogue box 610 that provides an action message for changing the format of rendering such as, for example, changing a color rendering format to a black and white rendering format with respect to the rendering device 140. The GUI 600 illustrates the action message for selecting an alternative rendering device 140 in the context of network 135. The system 200 and method 400 leverages existing mobile print technologies and extends managed print services with respect to a remote and mobile work force.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for providing print governance interaction with respect to a remote rendering job, said method comprising:
transmitting a rendering job in association with address information of a networked rendering device from a mobile communications device to a mobile print server via a print job submission tool;
providing a confirmation code to said mobile communications device by a print governance application configured in association with said mobile print server in order to thereafter enter said confirmation code via an extensible interface platform application configured at said rendering device to retrieve said rendering job; and
displaying a print governance message at a user interface of said rendering device if said rendering job activity bypasses said at least one print governance policy in order to provide an effective print governance solution in a wide range of remote rendering applications.

2. The method of claim 1 further comprising permitting a user to make changes to said rendering job activity that bypasses said at least one print governance policy via an option button.

3. The method of claim 1 further comprising presenting said print governance message as said extensible interface platform application dialogue while releasing said rendering job.

4. The method of claim 1 further comprising providing detailed information and an action to be taken by said print governance message when said rendering job bypasses said at least one print governance policy.

5. The method of claim 1 wherein said print job submission tool comprises an e-mail application.

6. A system for providing print governance interaction with respect to a remote rendering job, said system comprising:
a processor;
a data bus coupled to said processor; and
a computer-usable medium embodying computer code, said computer-usable medium being coupled to said data bus, said computer program code comprising instructions executable by said processor and configured for:
transmitting a rendering job in association with address information of a networked rendering device from a mobile communications device to a mobile print server via a print job submission tool;
providing a confirmation code to said mobile communications device by a print governance application configured in association with said mobile print server in order to thereafter enter said confirmation code via an extensible interface platform application configured at said rendering device to retrieve said rendering job; and
displaying a print governance message at a user interface of said rendering device if said rendering job activity bypasses said at least one print governance policy in order to provide an effective print governance solution in a wide range of remote rendering applications.

7. The system of claim 6 wherein said instructions are further configured for permitting a user to make changes to said rendering job activity that bypasses said at least one print governance policy via an option button.

8. The system of claim 6 wherein said instructions are further configured for presenting said print governance message as said extensible interface platform application dialogue while releasing said rendering job.

9. The system of claim 6 wherein said instructions are further configured for providing detailed information and an action to be taken by said print governance message when said rendering job bypasses said at least one print governance policy.

10. The system of claim 6 wherein said print job submission tool comprises an e-mail application.

11. The system of claim 6 wherein said instructions are further configured for:
permitting a user to make changes to said rendering job activity that bypasses said at least one print governance policy via an option button; and
presenting said print governance message as said extensible interface platform application dialogue while releasing said rendering job.

12. The system of claim 6 wherein said instructions are further configured for:
presenting said print governance message as said extensible interface platform application dialogue while releasing said rendering job; and
providing detailed information and an action to be taken by said print governance message when said rendering job bypasses said at least one print governance policy.

13. The system of claim 6 wherein said instructions are further configured for:
permitting a user to make changes to said rendering job activity that bypasses said at least one print governance policy via an option button; and
providing detailed information and an action to be taken by said print governance message when said rendering job bypasses said at least one print governance policy.

14. The system of claim 11 wherein said print job submission tool comprises an e-mail application.

15. The system of claim 12 wherein said print job submission tool comprises an e-mail application.

16. The system of claim 13 wherein said print job submission tool comprises an e-mail application.

17. A computer-usable for providing print governance interaction with respect to a remote rendering job, said computer-usable medium embodying computer program code, said computer program code comprising computer executable instructions configured for:
transmitting a rendering job in association with address information of a networked rendering device from a mobile communications device to a mobile print server via a print job submission tool;
providing a confirmation code to said mobile communications device by a print governance application configured in association with said mobile print server in order to thereafter enter said confirmation code via an extensible interface platform application configured at said rendering device to retrieve said rendering job; and
displaying a print governance message at a user interface of said rendering device if said rendering job activity bypasses said at least one print governance policy in order to provide an effective print governance solution in a wide range of remote rendering applications.

18. The computer usable medium of claim 17 wherein said embodied computer program code further comprises computer executable instructions configured for permitting a user to make changes to said rendering job activity that bypasses said at least one print governance policy via an option button.

19. The computer usable medium of claim 17 wherein said embodied computer program code further comprises computer executable instructions configured for presenting said print governance message as said extensible interface platform application dialogue while releasing said rendering job.

20. The computer usable medium of claim 17 wherein said embodied computer program code further comprises computer executable instructions configured for providing detailed information and an action to be taken by said print governance message when said rendering job bypasses said at least one print governance policy.
